(19) United States
(12) Patent Application Publication
(10) Pub. No.: US 2022/0390150 A1
(43) Pub. Date: Dec. 8, 2022

(54) COOLING SYSTEM WITH REDUCED VALVES

(71) Applicant: OxiCool Inc., Malvern, PA (US)

(72) Inventors: Ravikant T. Barot, Phoenixville, PA (US); Brandon K. Wilcox, Downingtown, PA (US)

(73) Assignee: OxiCool Inc., Malvern, PA (US)

(21) Appl. No.: 17/755,712

(22) PCT Filed: Nov. 6, 2020
(86) PCT No.: PCT/US2020/059394

§ 371 Date: May 5, 2022

Related U.S. Application Data
(60) Provisional application No. 62/940,033, filed on Nov. 25, 2019.
(60) Provisional application No. 62/933,149, filed on Nov. 8, 2019.

(51) Int. Cl. F25B 17/08; F25B 49/04

(52) U.S. Cl. CPC F25B 17/083; F25B 49/046

(57) ABSTRACT

Technologies are described herein for cooling systems. In some examples, a cooling system uses cooling cells to provide cooling to a space. The cells can include one or more adsorption chambers, whereby an adsorbent in the adsorption chamber causes a refrigerant (such as water) to evaporate. The action of evaporation removes heat from a cooling fluid, which is used to cool the space.

### CROSS REFERENCE TO RELATED APPLICATIONS

This application claims the benefit of U.S. Provisional Application No. 62/933,149 filed Nov. 8, 2019, entitled “Cooling System” and U.S. Provisional Application No. 62/940,033 filed Nov. 25, 2019, entitled “Cooling System,” which are incorporated herein by reference in their entirety.

### BACKGROUND

Conventional cooling systems typically use phase changing refrigerants as the working fluid. The phase changing refrigerants are often compressed and, upon vaporization, absorb heat from the surrounding environment. The absorption of the heat cools the surrounding environment or another fluid. A plurality of liquid refrigerant systems, especially those for home use, are hydrofluorocarbon (HFC)-based systems. The refrigerants used in HFC-based systems are often greenhouse gases. There has been effort by the air conditioning industry to move to a more environmentally-friendly refrigerant. However, the industry has not succeeded and continues to use refrigerants such as R410a (also called PURON) which is a super greenhouse gas with GWP of 2088. It is with respect to these and other considerations that the disclosure made herein is presented.

### SUMMARY

Technologies are described herein for a cooling system that uses water as a refrigerant to provide cooling. The cooling system includes one or more cooling cells that provide chilled water or coolant to a chiller, whereby air moving through the chiller is cooled, providing cooling to a space. The cooling cells include one or more adsorbent chambers fluidly connected to a condenser/evaporator. The adsorbent chambers use an adsorbent to adsorb water vapor from the condenser/evaporator. The cooling cells also include one or more heaters to heat the adsorbent in the adsorbent chambers, causing the adsorbent to desorb water adsorbed into the adsorbent. In some examples, fans may be used, if needed, to condense the desorbed water vapor back into liquid water or cool the adsorbent in the adsorbent chamber, depending on the particular configuration or system requirements. In other examples, the vapor may be condensed back in a liquid through the use of a coolant such as cooled or chilled water, which removes heat from the vapor to condense the vapor. The chilled water may be provided using an internal or external heat exchanger.

In some examples, two or more cooling cells are provided. In some configurations, one cooling cell may be providing chilled water to the chiller (i.e. cooling mode), whereby the other cooling cell may be desorbing and condensing water (i.e. recharging mode), or, maybe placed in a “standby” condition after recharging. In other examples, both cooling cells may be placed into use to increase the cooling capacity of the cooling system, with each providing chilled water to the chiller. The two or more cooling cells may be operated in other manners.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an illustration of a cooling system.

FIGS. 2A-2C are illustration showing example duty cycles of cells.

FIG. 3 is an illustration of a cell that uses more than two adsorption chambers.

FIG. 4 is an illustration of a modular cooling system.

FIG. 5 is a backside illustration of a modular cooling system.

FIG. 6 is an illustration showing an alternate cooling cell.

FIG. 7 is an illustration showing a further alternate cooling cell in which a water reservoir can be raised or lowered to provide water to the cooling system.

FIGS. 8-11 are illustrations from various viewpoints illustrating a still further alternate cooling system.

FIG. 12 is an illustration showing an additional alternate cooling system.

### DETAILED DESCRIPTION

The following detailed description is directed to a cooling system that uses water as a refrigerant to provide cooling. As noted above, conventional cooling systems often use refrigerants that are expensive, harmful to the environment, and require specialized training and equipment to work on. If the coils or other components leak, or any component containing any of the refrigerant needs to be replaced, the technician will have to use special equipment to evacuate the refrigerant to work on the system. Rather than using a vapor-compression system as in most residential systems, various examples of the presently disclosed subject matter use an adsorbent with an affinity for a refrigerant. When the adsorbent is placed in fluidic communication with the refrigerant, the adsorbent causes the refrigerant to evaporate. The heat of vaporization is thermally transferred from a liquid (or air) into the refrigerant, thus cooling down the liquid. The cooled, or chilled, liquid is then pumped through coils into a chiller, whereby air from a space is blown over the coils, reducing the temperature of the blown air. In some examples, the chilled liquid can be used to chill air, which is then pumped into air vents in a house or other structure to be cooled, rather than using space coolers in each space of the structure to be cooled. As used herein, a space cooler is a heat exchanger located in a space of a structure, wherein air from the space is pumped through the heat exchanger and cooled by the chilled liquid received from the evaporator.

In some examples, the adsorbent can be a molecular sieve. It should be understood that, while various examples described herein are described in terms of the use of-molecular sieve, the presently disclosed subject matter is not necessarily limited to molecular sieve, as other suitably equipped adsorbents, including, but not limited to, metal organic frameworks, zeolites, and electrically activated adsorbents, may be used. In some examples, electrically activated adsorbents, such as activated charcoal, can be adsorbents configured with an electrical charge to adsorb molecules. In some examples, the adsorbent is designed and/or selected to allow for the storage of the refrigerant on a molecular basis. For example, the crystalline structure of common forms of molecular sieves provide for the adsorption of a water molecule within the interstitial space in the crystalline structure of the adsorbent.

Adsorbing the refrigerant on a molecular basis can provide various advantages. For example, rather than using a potentially harmful substance such as a hydrocarbon-based refrigerant, various examples of the presently disclosed subject matter may use water as the refrigerant. Further, in some examples, because the water molecules are stored (adsorbed) separately within the interstitial spaces of the adsorbent, the water molecules are not able to join and do not have a state of either liquid, vapor, or ice. Thus, in some examples, cooling systems using certain combinations of crystalline adsorbent and refrigerant can withstand relatively lower temperatures than other cooling systems without the use of antifreeze agents.

In examples, the cooling system uses an adsorbent with a crystalline structure capable of adsorbing individual molecules of the refrigerant in the crystalline structure. In some examples, the adsorption of the individual molecules in the crystalline structure can reduce the probability of the freezing of the refrigerant if the system is exposed to temperatures near or below the freezing point of the refrigerant.

In some examples, the cooling system includes an evaporator fluidly coupled to an adsorption chamber. In a cooling mode, the refrigerant vaporizes, causing the evaporator to absorb heat. The adsorption chamber receives the refrigerant vapor. The adsorption chamber includes an adsorbent. The adsorbent adsorbs the refrigerant vapor in the crystalline structure of the adsorbent. In a recharging mode, heat is applied to the adsorbent, causing desorption of the refrigerant from the adsorbent. In some examples, more than one evaporator and/or adsorbent chamber can be used to maintain at least a portion of the cooling system in a cooling mode while allowing a recharging mode.

In some examples, there is a cooling system comprising at least one evaporator containing a refrigerant, at least one adsorbent chamber fluidly coupled to the at least one evaporator and containing adsorbent configured to provide adsorption of vaporized refrigerant from the at least one evaporator in a cooling mode and configured to provide desorption of the refrigerant to the at least one evaporator in a recharging mode, and a control system configured to control the adsorption and desorption of the refrigerant of the at least one adsorbent chamber between the cooling modes and recharging modes during a cooling cycle, wherein at the end of the cooling cycle the control system is programmed to cease desorption of the refrigerant from the at least one adsorbent chamber, allow adsorption of the vaporized refrigerant from the at least one evaporator and at the end of the adsorption cycle continue to maintain the at least one adsorbent chamber in an adsorbed state in a winterization configuration. In some examples, the structure of the condenser and the evaporator may be combined into a single unit, whereby the unit acts as an evaporator during an adsorption mode and a condenser in a desorption mode.

The crystalline structure of the adsorbent can be used to place the refrigerant in a form for other uses as well. For example, the structure can be used to place the refrigerant in a stable, secure form for transport. In some examples, when transported as a liquid, the weight of the refrigerant can move or shift when the carrier transporting the refrigerant moves. In some examples, placing the refrigerant in the crystalline structure of the adsorbent can stabilize the weight of the refrigerant, as the adsorbent acts to prevent movement of the refrigerant when adsorbed in the crystalline structure of the adsorbent. For example, an adsorbent chamber may be used to transport the refrigerant the adsorbent chamber is to use, thus reducing the number of steps needed to bring the adsorbent chamber online.

In the following detailed description, references are made to the accompanying drawings that form a part hereof, and in which are shown by way of illustration specific examples. Further, various figures may not show certain features, such as valves, the use and implementation of which would be known to those of ordinary skill in the relevant art. Referring now to the drawings, aspects of technologies for cooling systems will be presented.

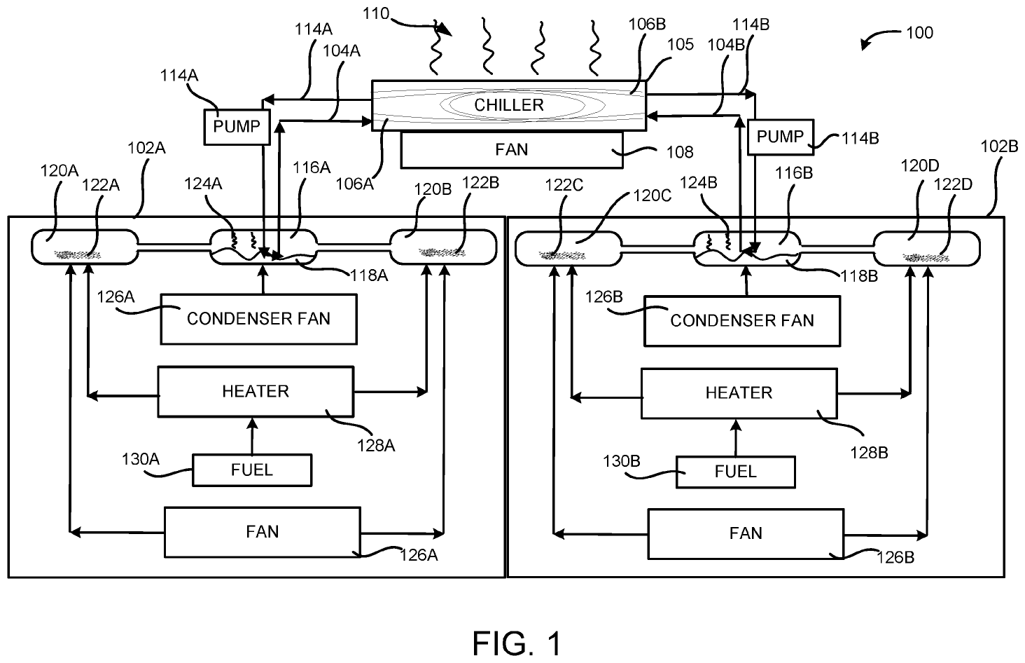

FIG. 1 is an illustration of a cooling system 100. In some examples of the presently disclosed subject matter, the cooling system 100 uses water and a valveless condensing/evaporation system to provide cooling without needing large vacuum grade valves typically needing to isolate the water vapor path between chambers—hereinafter called “valveless” design. In conventional systems that use adsorbents, when the mode of an adsorbent chamber is changed from the cooling mode, whereby the adsorbent is adsorbing vapor from the evaporator/condenser, to the recharging mode, whereby the adsorbent is desorbing the adsorbed water, valves are often used to prevent the reabsorption of water when the adsorbent chamber is in a standby mode after recharging. If the evaporator is not separated from the adsorbent chamber, the adsorbent may commence an undesired cooling mode. The valves, and the control systems that operate the valves, can be costly and can add complexity to the system.

In an attempt to reduce costs, as well as other potential benefits, the cooling system 100 of the presently disclosed subject matter does not use valves to separate adsorbent chambers from the evaporator/condensers. Instead, when the adsorbent has completed a recharge mode, whereby substantially all of the adsorbed water is desorbed, a minimal amount of heat is maintained on the adsorbent. The amount of heat is to keep the adsorbent above the temperature at which the adsorbent starts to adsorb. If maintained at that minimum temperature, the adsorbent will not appreciably adsorb the water, thus allowing the adsorbent chamber to remain in fluidic communication with the evaporator/condenser without the need for valves to isolate them.

The cooling system 100 includes one or more cooling cells that provide chilled water to a chiller, whereby air moving through the chiller is cooled, providing cooling to a space. The cooling cells include one or more adsorbent chambers fluidly connected to condenser/evaporator. The adsorbent chambers use an adsorbent to adsorb water vapor from the condenser/evaporator. The cooling cells also include one or more heaters to heat the adsorbent in the adsorbent chambers, causing the adsorbent to desorb water adsorbed into the adsorbent. In some examples, fans may be used, if needed, to condense the desorbed water vapor back into liquid water or cool the adsorbent in the adsorbent chamber, depending on the particular configuration or system requirements. As will be discussed in more detail, below, other methods may be used to cool desorbed vapor, including, but not limited to, water having a temperature that cools and condenses the vapor.

In some examples, two or more cooling cells are provided. In some configurations, one cooling cell may be providing chilled water to the chiller (i.e. in use), whereby the other cooling cell may be desorbing and condensing water (i.e. recharging), or, maybe placed in a “standby” condition after recharging. In other examples, both cooling cells may be placed into use to increase the cooling capacity of the cooling system, with each providing chilled water to the chiller. The two or more cooling cells may be operated in other manners.

In some examples, the standby cooling cells may be placed into the standby condition by providing heat to the adsorbent in the adsorbent chambers. The heat can be configured to maintain a high enough temperature of the adsorbent that prevents absorption, but low enough that, when removed, the adsorbent can be placed into service in a relatively short period of time. In some examples, once the heat is removed or reduced, the adsorbent temperature may reduce sufficiently for water adsorption by the cooling effect of natural circulation (i.e. the environment around the adsorbent), while in other configurations, a cooling medium, such as a fan, may be used to reduce the temperature of the adsorbent. Using heat to maintain a standby state, as well as the configuration of other components in the cooling system, provides for the reduction of the use of valves in the system, potentially decreasing the cost and increasing the reliability of the system.

In FIG. 1, there are cooling cells 102A and 102B. The cooling cells 102A and 102B supply chilled water 104A and 104B, respectively, into the chiller 105. The chiller 105 receives the chilled water 104A and 104B into coils 106A and 106B, respectively. A fan 108 blows air 110 over the coils 106A and 106B, reducing the temperature of the air 110 by exchanging the heat of the air 110 into the chilled water 104A and 104B. After receiving the heat from the air 110, the chilled water 104A and 104B are pumped out of the chiller 106 by pumps 112A and 112B, respectively, as warmed water 114A and 114B. It should be noted that although FIG. 1 illustrates separate pumps 112A, 112B, separate coils 106A, 106B, and the like, the presently disclosed subject matter is not limited to separate components as illustrated, as various configurations may include the combination of coils, pumps, and the like.

The warmed water 114A and 114B is received into evaporator/condensers 116A and 116B, respectively. The evaporator/condensers 116A and 116B includes a refrigerant 118A and 118B contained within the evaporator/condensers 116A and 116B. In some examples, the refrigerant 118A and 118B is water. In some examples, the refrigerant 118A and 118B is pure water. In some examples, the refrigerant 118A and 118B is substantially pure water. In some examples, the refrigerant 118A and 118B is water containing no additives. In other systems, water containing adjuvants may be desired as the refrigerant 118A and 118B. An example of useful adjuvants is an anti-microbial (e.g., bactericidal or fungicidal) composition. In some examples, the refrigerant 118A and 118B does not contain materials which would interfere with operation of cooling system 100 in its operation. Thus, in some examples, glycols and other antifreeze agents can be excluded from the refrigerant 118A and 118B.

The warmed water 114A and 114B is cooled by heat exchange with the refrigerant 118A and 118B in the evaporator/condensers 116A and 116B, respectively. The temperatures of the refrigerant 118A and 118B are reduced by heat removed from the refrigerant 118A and 118B when the refrigerant 118A and 118B vaporized, or the latent heat of vaporization. The refrigerant 118A and 118B vaporizes when placed in fluidic communication with an adsorbent with a high affinity for the refrigerant 118A and 118B.

In some examples, the evaporator/condensers 116A and 116B are fluidly coupled to adsorbent chambers 120A/120B of cooling cell 102A and 120C/D of cooling cell 102B, respectively. The adsorbent chambers 120A-D contain an adsorbent 122A-D, respectively. In some examples, the adsorbent 122A-D is a material configured to adsorb and desorb the refrigerant 118A and 118B. In some examples, the adsorbent 122A-D is configured to provide adsorption of vaporized refrigerant 124A and 124B from the evaporator/condensers 116A and 116B in a cooling mode and configured to provide desorption of the refrigerant 124A and 124B back into the evaporator/condensers 116A and 116B in a recharging mode.

In some examples, the adsorbent 122A-D exhibits a high ability to adsorb the refrigerant 124A and 124B and to remain in an adsorbed state over practical lengths of time, while maintaining physical and physicochemical form and function. Such materials may be useful when they exhibit a high ability to adsorb water, efficient and effectively reversible desorption of water upon application of heat energy, and physical and physicochemical stability during and following repeated adsorption and desorption cycles.

In some examples, the adsorbent 122A-D includes a desiccant material. In some examples, the adsorbent 122A-D is a desiccant. In some examples, the adsorbent 122A-D is zeolite. A zeolite may be described as, but without limitation, hydrous aluminum silicate in porous granules. Exemplary zeolites that may be used include analxime, chabazite, heulandite, natrolite, phillipsite and stilbite. In some examples, the adsorbent 122A-D is any drying agent that maintains its physical structure when substantially fully contacted with water. In other examples, the adsorbent 122A-D is any adsorptive and/or absorptive material including but not limited to diatomaceous earth, activated alumina, silica gel, calcium aluminosilicate clay, molecular sieves (e.g., electrically charged molecular sieves), metal organic framework materials, activated carbon, and/or lithium chloride. In other examples, the adsorbent 122A-D may be an electrically chargeable and dischargeable material (e.g., a porous slab or particles of material such as a metal including aluminum, stainless steel and alloys thereof) such that electrical energy is used to control the electrical charge of the pores of the material to adsorb and desorb the refrigerant 124A and 124B from the adsorbent 122A-D.

During the cooling mode, condensing fans 126A and 126B may be used to provide air around and/or through the evaporator/condensers 116A and 116B, respectively, to form a heat exchanger coupling between the air from the fans 126A and 126B and the evaporator/condensers 116A and 116B. In some configurations, including during an adsorption mode, the condensing fans 126A and 126B may also be used to cool adsorbent chambers to cool adsorbent 122A-D. It should be understood that the fans 126A and 126B may not be needed in certain configurations if natural circulation or other means of providing cooling to the evaporator/condensers 116A and 116B are available. Further, the use of air is merely by example, as other heat transfer mediums, such as water, glycol mixtures, antifreeze agents, oils, or other heat transfer media may be used.

As the vaporized refrigerant 124A and 124B moves from the evaporator/condensers 116A and 116B into the adsorbent chambers 120A and 120B, respectively, the pressure within the evaporator/condensers 116A and 116B decreases, reducing the boiling point of the refrigerant 124A and 124B, causing evaporation, thereby decreasing the temperature within the evaporator/condensers 116A and 116B, pulling heat from heat transfer medium chilled water 104A and 104B such that the temperature of the heat transfer medium chilled water 104A and 104B decreases.

During use, the vaporized refrigerant 124A and 124B are adsorbed into the adsorbent 122A and/or 122B for evaporator/condenser 116A, and, 122C and/or 122D for the evaporator/condenser 116B. To reset or recharge cooling system 100 and be ready for a subsequent cooling cycle, energy is applied to the adsorbent chambers 120A-D to cause the adsorbed refrigerant to desorb from the adsorbent 122A-122D and flow back into their respective evaporator/condensers 116A and 116B. In some examples, heaters 128A and 128B, having fuel sources 130A and 130B, respectively, or other heat source, is used to apply heat to the adsorbent 122A-D in the recharging mode. In some examples, the fans 126A and 126B are used to condense the desorbed refrigerant for subsequent cycles. In some examples, a fan is used to blow ambient air around the evaporator/condensers 116A and 116B to condense the desorbed refrigerant from vapor to liquid for subsequent cycles. It should be understood, however, that some examples of the cooling system 100 do not require the fans 126A and 126B, as the desorbed refrigerant may condense in the evaporator/condenser 104 based on the temperature of the refrigerant as well as the pressure in the evaporator/condenser 104. In some examples, a chiller or other cooling source may be used. For example, as will be discussed in more detail below, one fan (or set) may be used to cool the condenser/evaporator during desorption and another other fan (or set) may be used to cool the adsorbent chamber(s). In other configurations, the evaporator/condenser 104 and other components may be cooled using a coolant flowing through a secondary heat exchanger. In some examples, heat required for desorbing the adsorbent (or limiting/preventing adsorption) can come from other fuel sources such as diesel fuel, heating oil, or hydrogen. The presently disclosed subject matter is not limited to the heaters 128A and/or 128B being a particular burner. In still further examples, the heat can also come from sources such as solar thermal or from a heat transfer fluid (water, oil, etc.) that is heated from a central source (a building or community-based heat generation plant). The presently disclosed subject matter or any configuration described herein is not limited to any particular source of heat.

As noted above, the cooling system 100 is configured to reduce or eliminate the use of valves in certain areas. For example, in conventional cooling systems, valves are used to isolate the evaporator/condenser from adsorbent chambers when the adsorbent chambers are in a standby mode of operation. In these conventional systems, if the evaporator/condenser is not isolated from the adsorbent chambers during the standby mode (e.g. where all or substantially all of the refrigerant has been desorbed from the adsorbent), if at the right temperature, the adsorbent will start to adsorb refrigerant from the evaporator/condenser, thus undesirable commencing a cooling cycle.

Rather than using valves to isolate the evaporator/condensers 116A and 116B, the cooling system 100 of FIG. 1 uses heat applied to the adsorbent chambers 120A-D that are in standby mode. Applying heat to the adsorbent chambers 120A-D maintains the adsorbent 122A-D at a particular temperature that does not allow the adsorption of the refrigerant 118A and 118B into the adsorbent 122A-D, thus obviating the need to isolate the evaporator/condensers 116A and 116B. When a particular adsorbent chamber 120A-D is placed into a cooling mode, the heat from the heaters 128A or 128B is removed, allowing the respective adsorbent 122A-D to cool down and commence adsorption.

There are various ways in which the cooling cells 102A and 102B may be operated. For example, the cooling cell 102A may be placed into a cooling mode while the cooling cell 102B is placed into a recharging mode and thereafter a standby mode. When the adsorbent 122A and 122B of the cooling cell 102A has adsorbed a specified amount of the refrigerant 118A, the cooling cell 102A may be placed into a recharging mode while the cooling cell 102B is placed into a cooling mode. During a recharging mode, the heater 128A if cell 102A, or the heater 128B if the cell 102B, is initiated using fuel 130A or 130A (such as propane or natural gas). The increase in temperature of the adsorbent 122A-D caused the desorption of the refrigerant 118A/B. The desorbed refrigerant 118A/118B flows to the evaporator/condensers 116A and 116B, where the desorbed refrigerant 118A/B is condensed back into a liquid form. To place the cooling cell 102A or 102B into a standby mode, the heater 128A or 128B is reduced to apply enough heat to prevent the adsorption of the refrigerant 118A/B back into the adsorbent after the recharge mode.

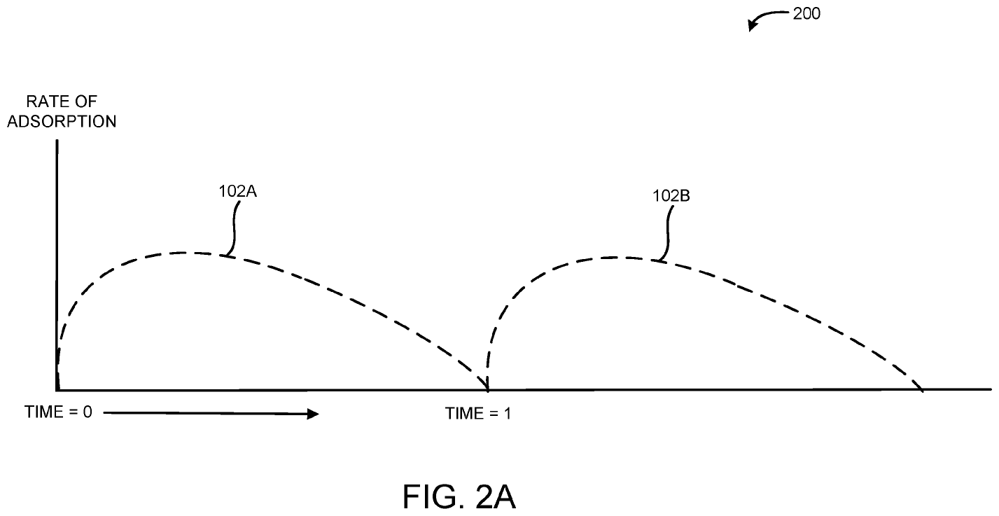

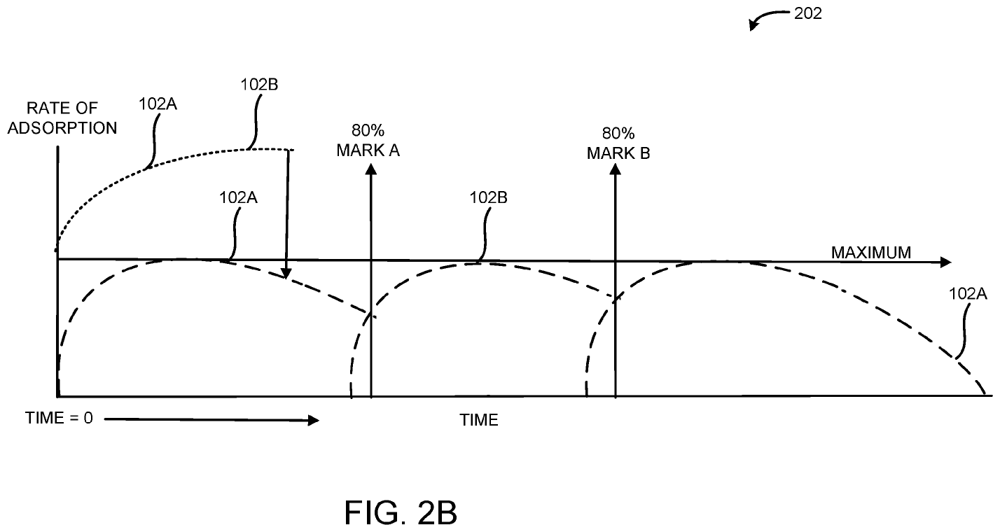

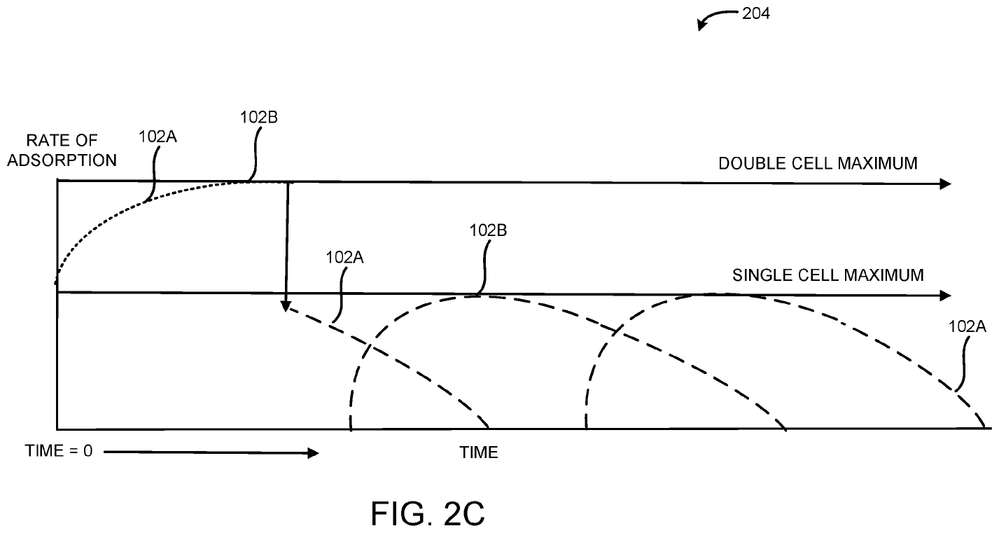

FIGS. 2A-2C are illustration showing example duty cycles of the cells 102A and 102B. The y-axis indicates a rate of adsorption (and thus rate of cooling) and the x-axis indicates time. In the duty cycle 200 shown in FIG. 2A, at time=0, the cell 102A is placed into the cooling mode, whereby the cell 102B is maintained in the standby or recharging (and then standby) mode. At time=1, whereby the rate of adsorption for the cell 102A has decreased to a predetermined value, the cell 102B is placed into the cooling mode and the cell 102A is placed into the recharging (and then standby) mode. Thus, in this configuration, constant cooling of a space may be provided.

In some examples, the duty cycle 200 may have some disadvantages. For example, because the cell 102B is not brought into the cooling mode until the rate of adsorption of the cell 102A has decreased significantly, the rate of cooling of the space may vary beyond a desired or acceptable amount. For example, at time=1, the rate of cooling may be diminished to the point that little cooling is occurring.

The duty cycle 202 of FIG. 2B may be used to maintain cooling above an acceptable level. As indicated in the duty cycle 202, close to time=0, there is a large rate of cooling, as there are a lot of sites in the adsorbent 122A/B to adsorb the refrigerant 118A. It should be noted that various factors, such as the heat of the adsorbent, may affect the rate of adsorption. As time moves from time=0 to 80% Mark A, the rate of adsorption of the cell 102A has decreased to approximately 80% of the maximum rate of adsorption for the cell 102A. To maintain cooling, rather than simply letting the rate of adsorption of the cell 102A to decrease further and then bringing the cell 102B into the cooling mode, at the 80% mark A, the cooling cell 102B is brought into the cooling mode, thereby adding to the cooling provided by the cell 102A, maintaining an acceptable or desired level of cooling. The cell 102A is placed into the recharge mode (and then the standby mode). Similarly, at the 80% mark B, indicating that the rate of adsorption of the cell 102B has decreased to 80% of the maximum rate, the cell 102A is placed into the cooling mode and the cell 102B is placed into the recharging mode. In some examples, the cell placed into the recharging mode may be operated for a period of time after the 80% mark A or B. It should be noted that the use of “80%” is merely exemplary, as other percent reductions may be used and are considered to be within the scope of the presently disclosed subject matter. For example, the adsorption rate of the cooling cell in the cooling mode may be allowed be reduce to a rate higher or lower than 80%.

FIG. 2C is an illustration of a duty cycle 204 in which a maximum amount of cooling is provided for a period of time. In the duty cycle 204, at time=0, both the cell 102A and the cell 102B are placed into the cooling mode. This increases the total rate of adsorption from the maximum for a single cell to the maximum for a double cell. Thus, the rate of cooling may be increased beyond the maximum when using a single cell.

This may be especially useful if it is desirable for a space to be quickly cooled, and then maintained thereafter by the operation of a single cell. For example, in conventional air conditioning systems, prior to the homeowner coming home, the homeowner may program the air conditioner to turn on, thus cooling the house for the arrival of the homeowner. However, this can waste energy, as an unoccupied space is being cooled. The entire time the homeowner (or other occupant) is not in the home, the time of which may be increased if the homeowner experiences delays such as traffic, the cooling is happening in an unoccupied space.

The duty cycle 204 can help alleviate and reduce the waste of energy. Rather than cooling an unoccupied space for an extended period of time, both the cells 102A and 102B may be placed in the cooling mode to quickly cool the home. At a particular time of operation, the cell 102B may be placed back into a recharge mode (and then standby mode), whereby the cell 102A is maintained in service. The cells 102A and 102B may be alternated to provide continual cooling to a space.

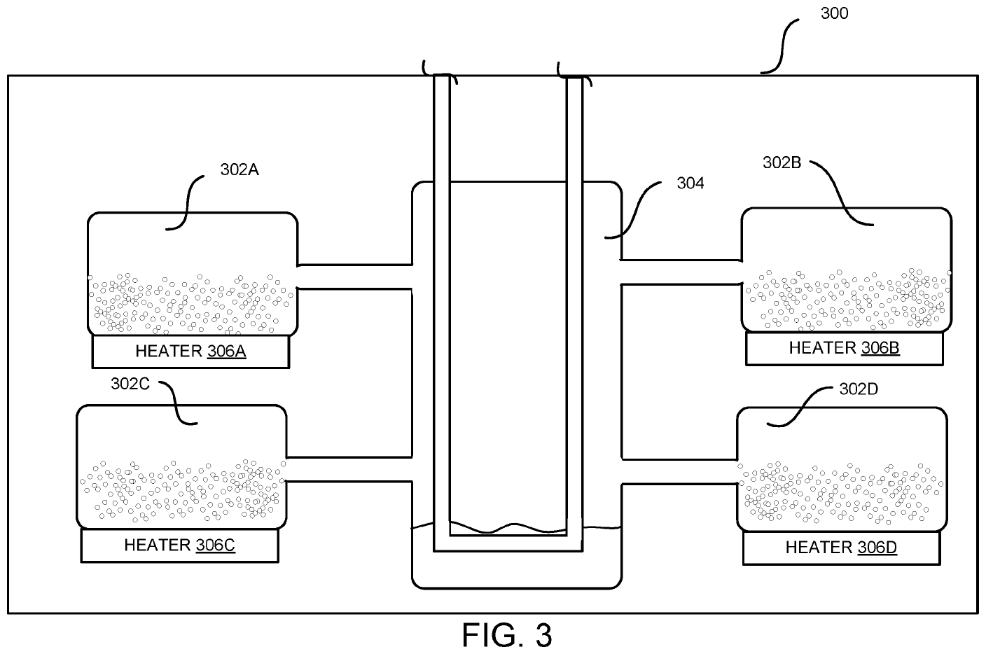

FIG. 3 is an illustration of a cell 300 that uses more than two adsorption chambers. As illustrated in FIG. 3, the cell 300 includes four adsorption chambers, adsorption chambers 302A-302D, rather than two adsorption chambers as illustrated in FIG. 1. The adsorption chambers 302A-302D may be in fluidic communication with an evaporator/condenser 304. It should be noted that although one evaporator/condenser 304 is illustrated, a cell may have more than one evaporator/condenser 304, which may be placed in fluidic communication with various combinations of adsorption chambers. The adsorption chambers 302A-302D receive heat from heaters 306A-306B, respectively. It should be noted that one or more of the heaters 306A-306D may heat one or more of the adsorption chambers 302A-302D in various combinations.

In some examples, the cells may be used in a modular fashion. In conventional cooling systems that use compressible refrigerants like freon, increasing or decreasing the capacity of the cooling system requires the changeout of a significant number of components, most of which are expensive, like the compressor. Units are designed to have a specific tonnage of cooling capacity. To increase the cooling capacity of conventional systems, another unit may need to be installed or expensive components of the current system may need to be changed (such as the compressor).

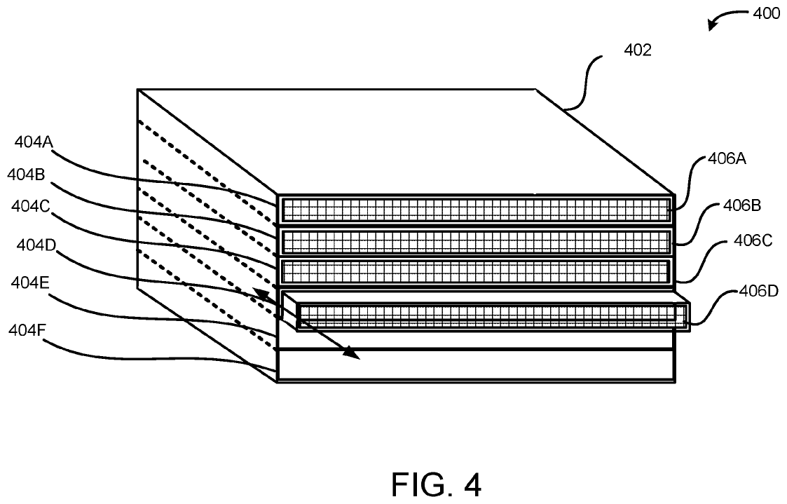

FIG. 4 is an illustration of a modular cooling system 400. The modular cooling system 400 allows for the installation and removal of cooling cells, such as the cells 102A and 102B illustrated in FIG. 1, to increase or decrease the cooling capacity of the modular cooling system 400. Because the module cooling system 500 does not use a refrigeration cycle as in systems that use compressible refrigerants, the cooling capacity of the modular cooling system 500 may be increased or decreased by adding cells, without the need to significantly change the system or adding another air conditioning system.

The modular cooling system 400 of FIG. 4 includes an outer case 402. The outer case 402 has installed therein bays 404A-F. The bays 404A-F are voids in the outer case 402 sized to receive one or more cooling cells. Shown in FIG. 4, a cell 406A is installed in the bay 404A, a cell 406B is installed in the bay 404B, and a cell 406C is installed in the bay 404A. A cell 406D is partially installed in the bay 404D, showing how, in this particular embodiment, the cells may be inserted or removed by sliding the cell into or out of the bays. It should be noted that, for ease of illustration, various parts of the outer case, such as a door or other enclosing surfaces, are not illustrated.

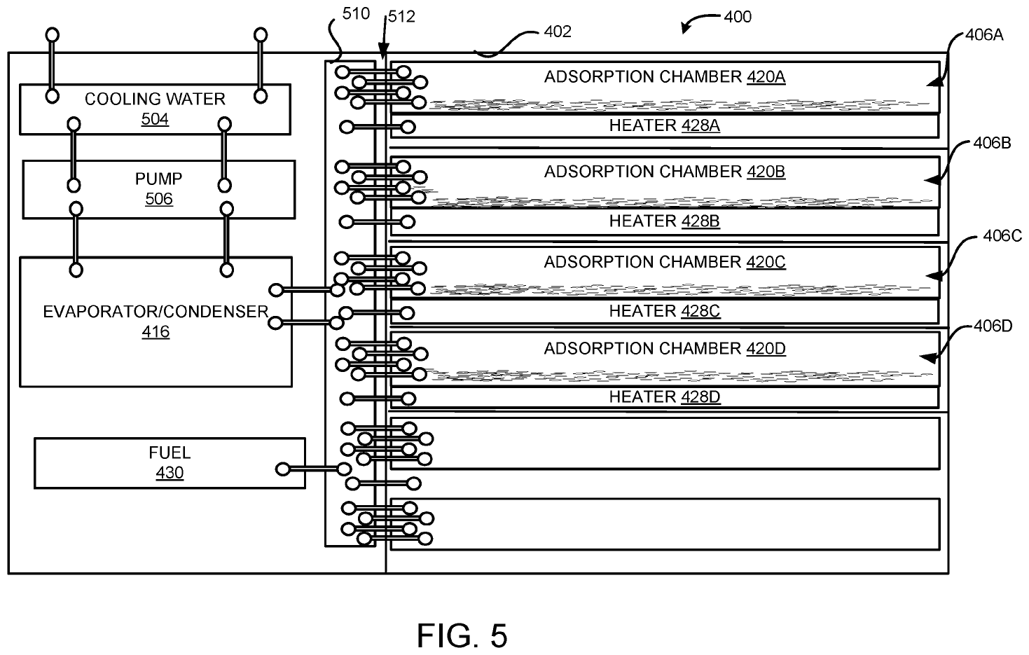

FIG. 5 is a backside illustration of the modular cooling system 400 of FIG. 4. The modular cooling system 400 has installed therein the cells 406A-406D. The cells 406A-406D includes adsorption chambers 420A-402D and heaters 428A-428D, respectively. The modular cooling system 400 further includes a pump 506 that pumps cooled cooling water 504 that is cooled from the evaporation of refrigerant in the evaporator/condenser 416 in a manner similar to that described in FIG. 1. The modular cooling system further includes fuel 430 to provide fuel to the heaters 428A-D.

To allow for the connection and disconnection of cells, such as the cells 406A-D to the modular cooling system 400, the module cooling system 400 further includes a manifold 510. The manifold 510 includes internal ports and chambers, as is known in the current art, to provide passageways for the various fluids in the modular cooling system 400 using the connections 512. The connections 512 may be quick disconnects, manual connections, and the like. For example, the manifold 510 includes a port from the fuel 430 to each of the heaters 428A-D to provide fuel to run the heaters 428A-D. In another example, the manifold 510 includes ports to facilitate the flow of water vapor to and from the evaporator/condenser 416 into one or more of the adsorption chambers 420A-D.

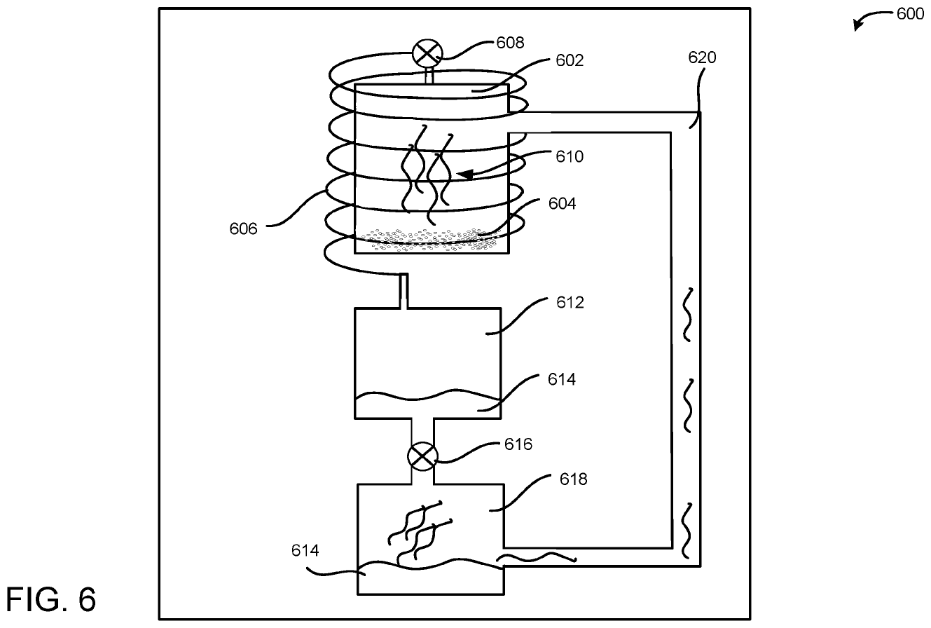

FIG. 6 is an illustration showing an alternate cooling cell 600 that may be used in one or more examples disclosed herein. The cooling cell 600 can be connected to one or more cooling systems, such as the cooling system of FIG. 1, and operated as a cooling cell. As illustrated in FIG. 6, the cooling cell 600 includes an adsorbent chamber 602 having an adsorbent 604 enclosed therein, constructed and operated in a manner similar to adsorbent chambers and adsorbents described hereinabove.

The cooling cell 600 further includes a condensing coil 606 in fluidic communication with the adsorbent chamber 602 through valve 608. When valve 608 is open, refrigerant vapor 610, which may be water as described hereinabove, passes into the coil 606 through the valve 608. The water vapor 610 condenses partially or completely in the coil 606, eventually draining, by way of gravity, into a water reservoir 612. To assist with condensing, a fan or other cooling medium (not shown) may be used to transfer heat out of the vapor in a heat exchange operation.

The water reservoir 612 is used to collect the condensed water vapor 610, now indicated as refrigerant 614. During the period in which the water vapor 610 is condensing in the coil 606, a valve 616 is closed. The valve 616 is used to place the water reservoir 612 into fluidic communication with an evaporator 618. The valve 616 is opened and closed to maintain a level of the refrigerant 614 (which is liquid) at a desired level. During a cooling mode, whereby the adsorbent is adsorbing the refrigerant 614 in the evaporator 618, the valve 608 is closed and the valve 616 is opened intermittently to maintain a desired level of the refrigerant 614 in the evaporator 618. The refrigerant 614 evaporates and moves through tube 620 into the adsorbent chamber 602 to be adsorbed by the adsorbent 604. To change from the cooling mode to a recharge mode, the valve 616 is closed and the valve 608 is opened. Heat is applied to the adsorbent using various methods including those described hereinabove. The adsorbed refrigerant 614 is desorbed as the water vapor 610, is condensed in the coil 606, eventually draining into the water reservoir 612. Some of the water vapor 610 may enter the tube 620. However, once a particular partial pressure is built up in the evaporator 618 and the tube 620, the water vapor 610 will be driven to the lower partial pressure of the condensing vapor in the coil 606.

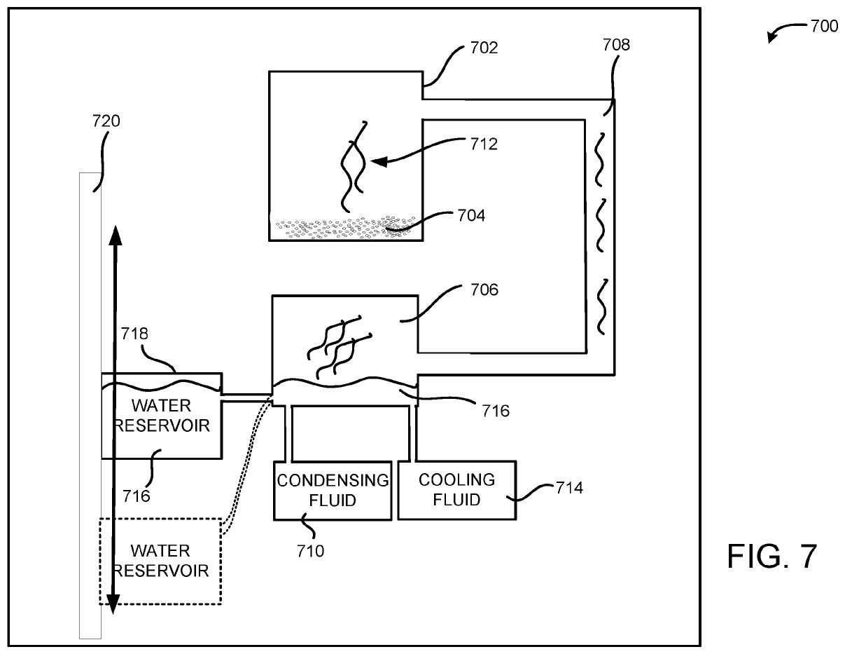

FIG. 7 is an illustration showing an alternate cooling cell 700 that may be used in one or more examples disclosed herein. The cooling cell 700 can be connected to one or more cooling systems, such as the cooling system of FIG. 1, and operated as a cooling cell. As illustrated in FIG. 7, the cooling cell 700 includes an adsorbent chamber 702 having an adsorbent 704 enclosed therein, constructed and operated in a manner similar to adsorbent chambers and adsorbents described hereinabove.

The cooling cell 700 further includes an evaporator/condenser 706. The evaporator/condenser 706 is fluidly coupled to the adsorbent chamber 702 via a fluid passageway 708 such as a pipe or conduit. The evaporator/condenser 706 is configured to receive condensing fluid 710 in one or more internal coils to the evaporator/condenser 706. The condensing fluid 710 may be water, air, or other fluid that is configured to cause water vapor 712 removed from the adsorbent 704 during a recharge operation to condense in the evaporator/condenser 706. The evaporator/condenser 706 is in further fluidic communication with a cooling fluid 714 which is configured to move through the evaporator/condenser 706 in internal coils (not shown) to the evaporator/condenser 706. When configured to operate as an evaporator, i.e. when the adsorbent 704 is adsorbing the water vapor 712, the act of evaporation of the refrigerant 716 in the evaporator/condenser 706 reduces the temperature of the cooling fluid 714, which is pumped to cool a space.

During some operations, the amount of water condensing in the evaporator/condenser 706 may need to be controlled. In this manner, the evaporator/condenser 706 is in fluidic communication with a water reservoir 718. The water reservoir 718 is used to maintain the level of the refrigerant 716 in the evaporator/condenser 706 at an optimal level. In some examples, the refrigerant 716 collected in the water reservoir 718 may be provided to the evaporator/condenser 706 by means of a differential pressure. When the adsorbent is adsorbing the water vapor 712, a slight vacuum is created in the adsorbent chamber 702. This vacuum propagates to the water reservoir 718, where the vacuum pulls the refrigerant 716 into the evaporator/condenser 706.

In some examples, the water reservoir 718 may be installed on a movable track 720 that raises or lowers the level of the water reservoir 718 in relation to the evaporator/condenser 706. In that manner, gravity can be used to allow the water reservoir 718 to receive the refrigerant 716 and, if raised to a desired level, allow the water reservoir to provide the refrigerant 716 to the evaporator/condenser 706. It should be understood that the water reservoir 718 in the configurations described in FIG. 7 may be used with other configurations, such as those described in the figures, above.

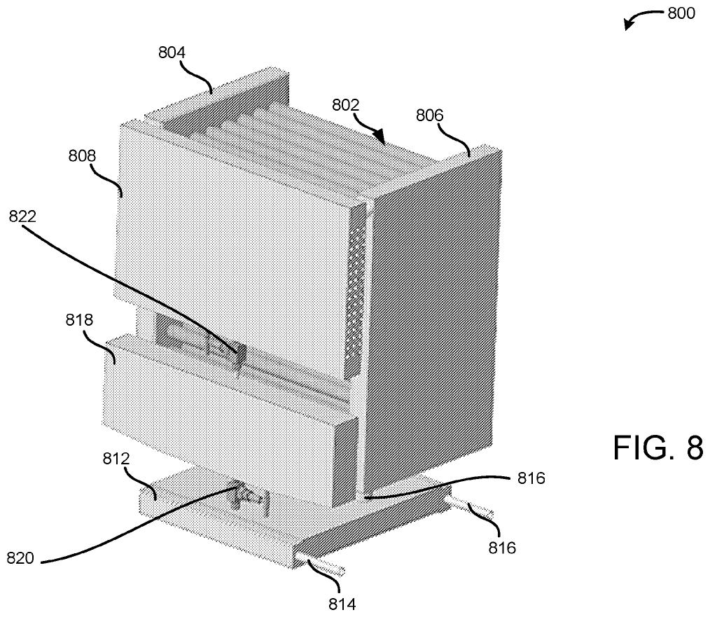

FIGS. 8-18 are illustrations from various viewpoints illustrating a still further alternate cooling system. Illustrated in FIG. 8 is a cooling unit 800 having adsorbent cells 802, water vapor plenum 804, water vapor plenum 806, condenser 808, water reservoir 818, and evaporator 812. The cooling unit 800 components operate in a manner similar to other examples provided herein. To provide cooling to an airspace (not shown), a water inlet 814 of the evaporator 812 receives water (or other coolant) at a first temperature and outputs the coolant from a water outlet 814 of the evaporator 812 at a lower, second temperature. The water is reduced in temperature by the evaporative action of refrigerant inside the evaporator 812. The valve 820 is opened and the valve 822 is closed so that the adsorbent cells 802 are placed in fluidic communication with the refrigerant in the reservoir 818 and the refrigerant (e.g. water) in the evaporator 812. The adsorbent cells 802 cause the refrigerant to evaporate, resulting in a reduction of the water leaving the water outlet 814. The refrigerant that is evaporated travel to the adsorbent cells 802 through the plenums 804 and 806.

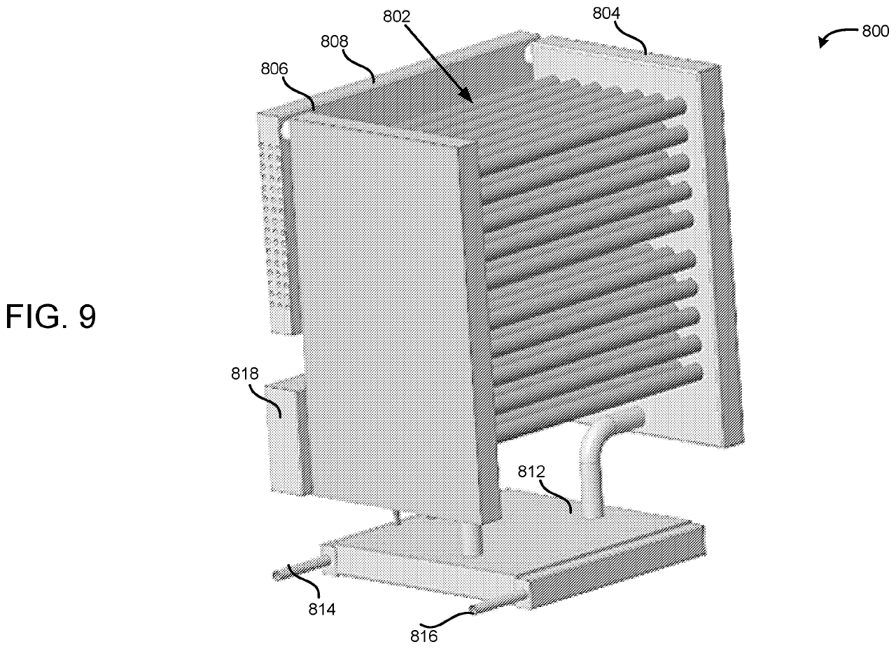

When the adsorbent cells 802 have adsorbed a predetermine amount of refrigerant, the valve 820 is closed and the valve 822 is opened. The adsorbent cells 802 may have heat introduced to drive the adsorbed refrigerant from the adsorbent (e.g. zeolite) contained in the adsorbent cells 802. The adsorbed refrigerant desorbs and leaves the adsorbent cells through the plenums 804 and 806 into the condenser 808. The condenser 808 includes tubes through which moves a lower temperature coolant (in some configurations, the coolant may be air or other fluid) to cause the desorbed refrigerant (which is in vapor form) to condense back into a liquid form for collection in the water reservoir 818. As noted above, in some examples, a portion of the refrigerant desorbed from the adsorbent cells 802 may condense and collect in the evaporator 812. This may happen in some configurations. FIGS. 9-18 are further illustrations of the cooling unit 800 from various perspectives and with some surfaces removed for additional clarity.

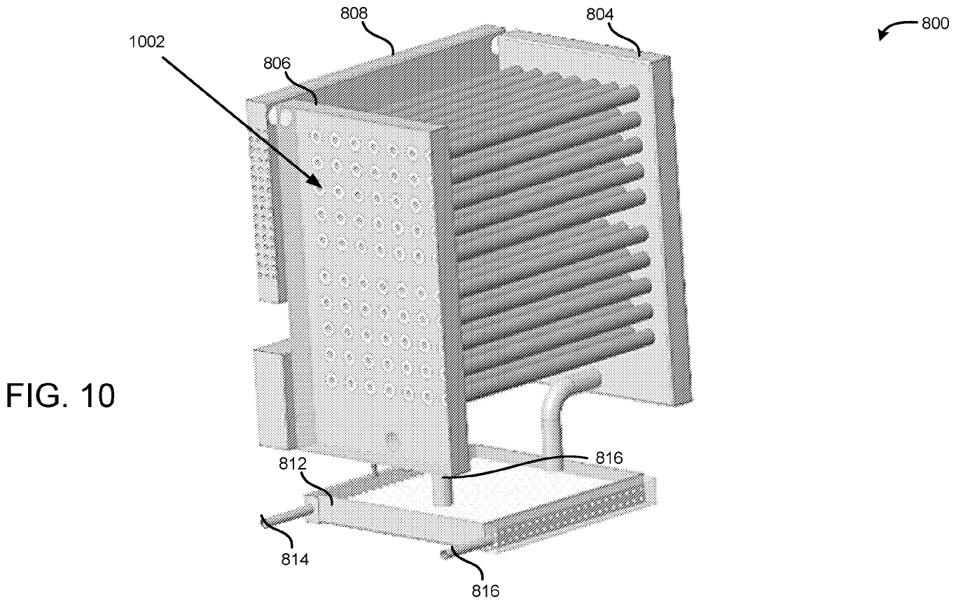

FIG. 10 illustrates the cooling unit 800 plenum 806 in further detail. As illustrated in FIG. 10, an outer wall of the plenum 806 has been removed, showing the internal structure of the plenum 806. The plenum 806 includes, internally to the plenum 806, inlets 1002 which are in fluidic communication with the adsorbent cells 802, allowing vapor/liquid to move into and out of the adsorbent cells 802 through the inlets 1002 and into/out of the plenum 806. The plenum 804 is similarly configured.

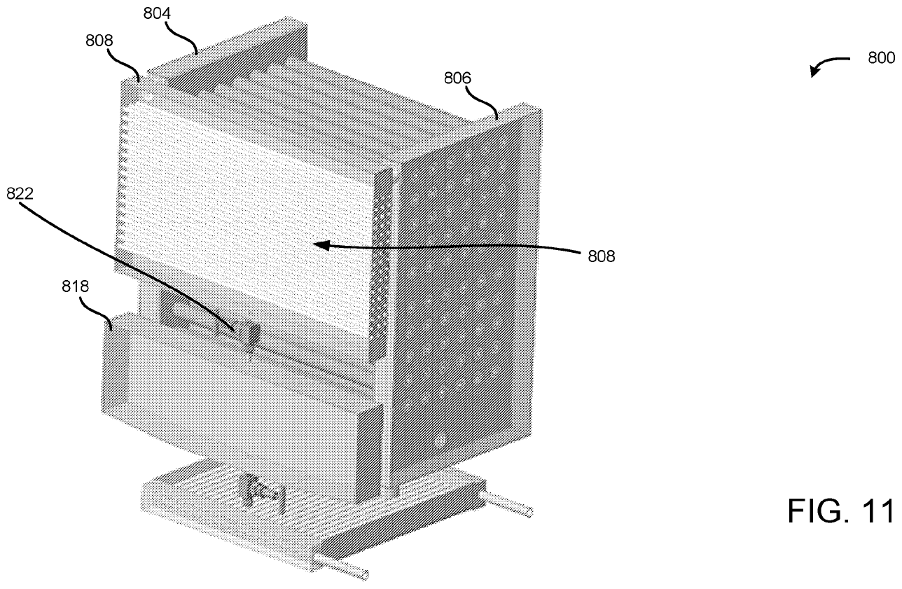

FIG. 11 illustrates the cooling unit 800 condenser 808. The condenser 808 includes, internally to the condenser 808, heat exchange tubes 1102 that allow vapor from the plenum 804 or plenum 806 to condense using various forms of cooling such as, but not limited to, forced air, chilled water, and the like. The condensed vapor from the condenser 808 flows down into the water reservoir 818 for future use.

Based on the foregoing, it should be appreciated that technologies for a cooling system have been disclosed herein. Although the subject matter presented herein has been described in language specific to structural features, methodological and transformative acts, and specific machinery, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, aspects of which are set forth in the following claims.

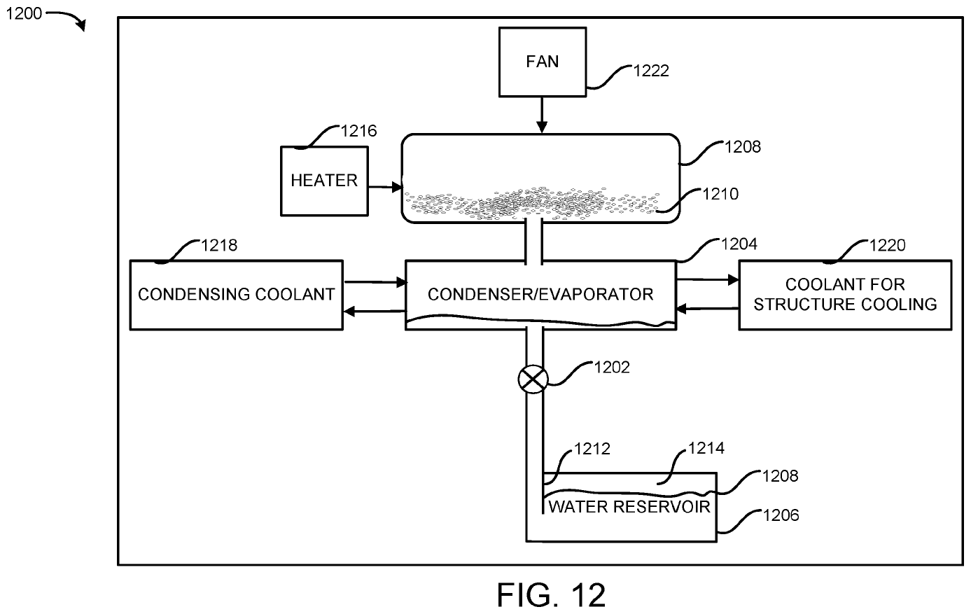

FIG. 12 is an illustration showing an additional alternate cooling system 1200. In some conventional cooling systems, in order to stop adsorption by the adsorbent, typically heat is applied to the adsorbent. The heat reduces, and then stops, the ability of the adsorbent to adsorb water. In these systems, the requirement for heat to be maintained on the adsorbent to prevent adsorbing can increase the usage costs of the cooling system. In the configuration of the cooling system 1200 illustrated in FIG. 12, a valve 1202 is placed between a condenser/evaporator 1204 and a water reservoir 1206. The water reservoir 1206 is used to sequester liquid refrigerant 1208 from an adsorbent chamber 1208 containing an adsorbent 1210. When it is desired to stop or reduce the amount of adsorption by the adsorbent 1210, the valve 1202 may be partially or fully closed, separating the liquid refrigerant 1208 from adsorbent chamber 1208, reducing or eliminating adsorption. The water reservoir 1206 may further include within the water reservoir 1206 a vapor barrier 1212. The vapor barrier 1212 is configured to be below the upper level of the liquid refrigerant 1208, creating a vapor sequestration area 1214 within the water reservoir 1206. The vapor sequestration area 1214 is configured to allow primarily only the refrigerant 1208 in liquid form to move through the valve 1202. In some examples, using a liquid connection can reduce the cost of the valve while increasing its longevity.

When in a desorption mode, a heater 1216 may be used to apply heat to the adsorbent 1210. The heat from the heater 1216 causes adsorbed refrigerant 1208 to be expelled from the structure of the adsorbent 1210. In all configurations, the heat required for desorbing the adsorbent (or limiting/preventing adsorption) can come from various fuel sources such as natural gas, propane, diesel fuel, heating oil, or hydrogen. The heat does not need to be from a burner using natural gas, propane, or other fuel. The heat can also come from sources such as solar thermal or from a heat transfer fluid (water, oil, etc.) that is heated from a central source (a building or community-based heat generation plant).

The expelled refrigerant 1208 is in the form of a vapor. The vapor travels to the condenser/evaporator 1204. To condense the vapor, a condensing coolant 1218 may be used. The condensing coolant 1218 may be chilled water or other relatively low temperature fluid (including air) that travels through tubes (not shown) within the condenser/evaporator 1204, removing heat from the vapor, returning the refrigerant 1208 from a vapor form to a liquid form. Other methods of cooling the vapor, including forced air, may be used and are considered to be within the scope of the presently disclosed subject matter.

In an adsorption operation, whereby an interior space of a structure is to be cooled, the valve 1202 may be opened (depending on the amount of the refrigerant 1208 in the condenser/evaporator 1204). The adsorbent 1210 is allowed to commence adsorbing the refrigerant 1208 located in the condenser/evaporator 1204. The refrigerant 1208 evaporates to be adsorbed. The latent heat of vaporization is extracted from the refrigerant 1208 in the condenser/evaporator 1204, reducing the temperature of the refrigerant 1208. The cooled refrigerant 1208 is used to cool a space coolant 1220 to be used to cool an interior space of a structure. For example, the space coolant 1220 may be water pumped through tubes in the condenser/evaporator 1204. The cooled refrigerant 1208 reduces the temperature of the space coolant 1220, which may be piped into space coolers located in the space. In another example, the cooled refrigerant 1208 may be used to cool air that is pumped into various internal spaces in the structure. These and other examples are considered to be within the scope of the presently disclosed subject matter. During the adsorption cycle, to reduce or eliminate adsorption, in addition to or instead of closing the valve 1202, a fan 1222 may be used to control the rate of adsorption. During adsorption, the adsorbent 1210 will heat up. As the adsorbent 1210 continue to adsorb, unless the heat is removed, eventually the adsorbent will stop adsorbing (assuming there are still sites on the adsorbent 1210 for adsorption). Thus, during adsorption, the adsorbent 1210 may be cooled by the fan 1222. The speed of the fan may be changed to maintain a temperature of the adsorbent 1210. Because the adsorbent 1210 has different rates of adsorption for different temperatures, the fan 1222 may be used to change the rate of adsorption for the adsorbent 1210. In some examples, the fan 1222 may be turned off (or reduced in speed) to allow the adsorbent 1210 to reach a temperature whereby the rate of adsorption is reduced or stopped. To commence adsorption again, the fan 1222 may be turned back on to reduce the temperature of the adsorbent 1210, thereby recommencing adsorption and cooling of the space coolant 1220.

Based on the foregoing, it should be appreciated that technologies for a cooling system have been disclosed herein. Although the subject matter presented herein has been described in language specific to structural features, methodological and transformative acts, and specific machinery, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, aspects of which are set forth in the following claims.

1. A cooling system, comprising:
an adsorbent chamber fluidically coupled to a condenser/evaporator, the adsorbent chamber containing an adsorbent that absorbs a refrigerant in a cooling mode and desorbs the refrigerant in a recharging mode;
the condenser/evaporator fluidically coupled to the adsorbent chamber and a water reservoir, wherein the condenser/evaporator in the cooling mode provides for the evaporation of the refrigerant and in a recharging mode provides for the condensation of the refrigerant;
the water reservoir fluidically coupled to the condenser/evaporator, the water reservoir configured to provide refrigerant to the condenser/evaporator;
a valve to control a movement of refrigerant from and to the condenser/evaporator and the water reservoir; and
a fan configured to control a temperature of the adsorbent during the cooling mode, wherein a speed of the fan is reduced to allow the temperature of the adsorbent to increase, thereby reducing a rate of adsorption, and wherein the speed of the fan is increased to allow the temperature of the adsorbent to decrease, thereby increasing a rate of adsorption.

2. The cooling system of claim 1, further comprising a condensing coolant within the condenser/evaporator to condense the refrigerant that is vaporized when desorbed from the adsorbent in the recharging mode.

3. The cooling system of claim 1, further comprising a space coolant pumped through the condenser/evaporator during the cooling mode, whereby heat is removed from the space coolant by evaporation of the refrigerant in a cooling mode.

4. The cooling system of claim 1, wherein the water reservoir further comprises a vapor barrier to reduce an amount of vapor entering the condenser/evaporator from the water reservoir through the valve.

5. The cooling system of claim 1, further comprising a heater to heat at least a portion of the adsorbent to cause the adsorbent to desorb the refrigerant previously adsorbed in the adsorbent.

6. The cooling system of claim 5, wherein the heater is a propane heater, a natural gas heater, a diesel fuel heater, a solar heater, a heating oil heater, a hydrogen-powered heater, or a heat transfer fluid received from a central source.

7. The cooling system of claim 1, wherein the adsorbent comprises a molecular sieve.

8. The cooling system of claim 7, wherein the molecular sieve comprises zeolite.

9. The cooling system of claim 1, wherein the adsorbent comprises a metal organic framework.

10. A method of cooling an interior space, the method comprising:
providing refrigerant into a condenser/evaporator from a water reservoir, wherein the condenser/evaporator is in fluidic communication with the water reservoir through a valve configured to reduce or stop the passage of refrigerant between the condenser/evaporator and the water reservoir;
providing an adsorbent chamber containing an adsorbent that causes an evaporation of at least a portion of the refrigerant in the condenser/evaporator by adsorption of at least a portion of the refrigerant into the adsorbent, causing a reduction of a temperature of the refrigerant in the condenser/evaporator;
transferring at least a portion of heat from a space coolant used to cool at least one space of a structure to the refrigerant in the condenser/evaporator, causing a reduction in a temperature of the space coolant; and
changing a speed of a fan used to cool the adsorbent to change a rate of absorption of the refrigerant by the adsorbent.

11. The method of claim 10, further comprising applying heat to the adsorbent to cause the adsorbent to desorb at least a portion of the refrigerant adsorbed into the adsorbent.

12. The method of claim 10, further comprising closing the valve to reduce or eliminate a flow of the refrigerant from the water reservoir into the condenser/evaporator.
